(19) United States
(12) Patent Application Publication
(10) Pub. No.: US 2009/0008180 A1
(43) Pub. Date: Jan. 8, 2009

(54) RESILIENT MOUNTING ARRANGEMENT FOR A MOTORCYCLE RADIATOR

(76) Inventors: Anthony D. Stefanelli, Elkhorn, WI (US); Edward A. Weston, Cary, IL (US); Erik Buell, Mukwonago, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/772,471

(22) Filed: Jul. 2, 2007

(51) Int. Cl. B60K 11/04

(52) U.S. Cl. 180/229; 165/44

(57) ABSTRACT

A mounting member for mounting a radiator assembly on a motorcycle. The mounting member includes a central portion including a mounting location configured to be attached to a rigid structure of the motorcycle. The mounting member further includes first and second resilient legs extending outwardly from the central portion and including respective mounting locations configured to be attached to the radiator assembly. The mounting member is part of a resilient mounting arrangement for mounting the radiator assembly on the motorcycle.

### BACKGROUND

The present invention relates to motorcycle construction. More particularly, the invention relates to mounting arrangements for a radiator assembly.

In the prior art, motorcycles have been provided with various protective elements (e.g., pucks, sliders, etc.) that are designed to provide some level of protection to various components of the motorcycle, such as the frame, engine, or drive components. The protective elements may protect against damage from impact and/or abrasion.

### SUMMARY

In one embodiment, the invention provides a mounting member for mounting a radiator assembly to a motorcycle. The mounting member includes a central portion having a mounting location configured to be attached to a rigid structure of the motorcycle. The mounting member further includes first and second resilient legs extending outwardly from the central portion and including respective mounting locations configured to be attached to the radiator assembly.

In another embodiment, the invention provides a mounting arrangement for mounting a radiator assembly on a motorcycle. The mounting arrangement includes a radiator housing and a resilient mounting member coupled to the radiator housing and configured to secure the radiator assembly on the motorcycle. The resilient mounting member is configured to absorb impact loads to the radiator assembly by elastic deformation.

In yet another embodiment, the invention provides a motorcycle including a frame, an engine, a radiator in fluid communication with the engine, and a mounting arrangement for mounting the radiator on the motorcycle. The mounting arrangement includes a resilient mounting member positioned between the radiator and at least one of the frame and the engine.

Other aspects of the invention will become apparent by consideration of the detailed description and accompanying drawings.

### BRIEF DESCRIPTION OF THE DRAWINGS

FIG. 1 is a side view of a motorcycle having a radiator assembly embodying the present invention.

FIG. 2 is a front view of the motorcycle of FIG. 1.

FIG. 3 is a front exploded view of the radiator assembly of FIG. 1.

FIG. 4 is a side view of a portion of the motorcycle of FIG. 1 with the engine and a portion of the radiator assembly of FIG. 3 removed.

FIG. 5 is a perspective view of a frame of the motorcycle of FIG. 1 having a pair of radiator assemblies mounted thereon.

FIG. 6 is a front view of the frame and radiator assemblies of FIG. 5.

FIG. 7 is a side view of a resilient mounting member that is part of a mounting arrangement of each of the radiator assemblies illustrated in FIGS. 5 and 6.

FIG. 8 is a front view of the resilient mounting member of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

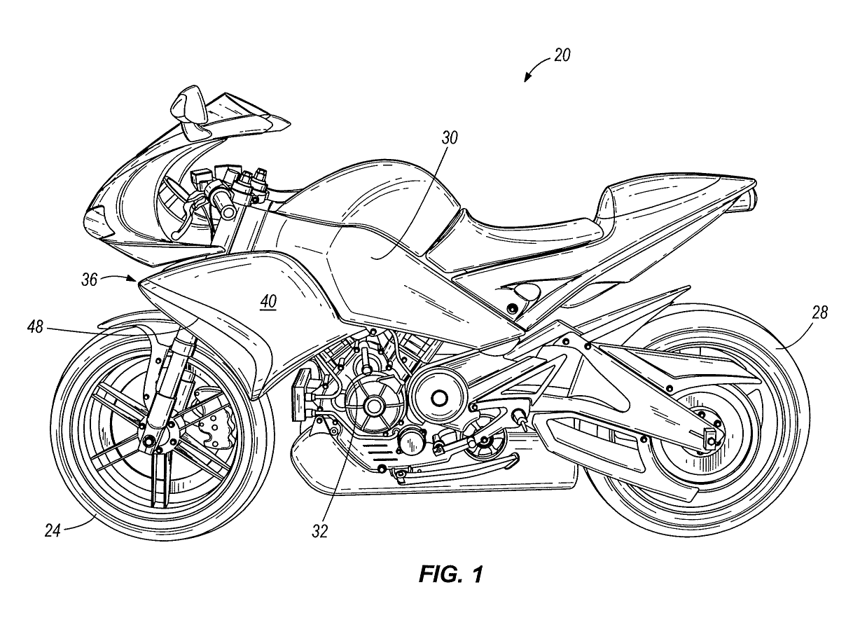

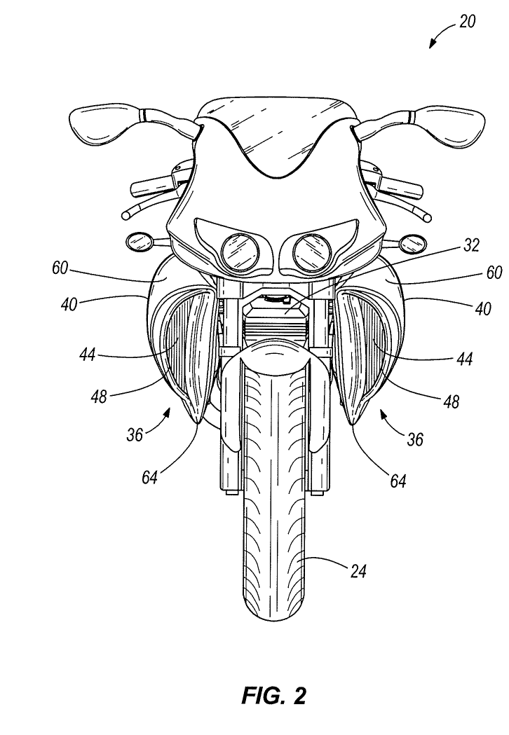

As shown in FIGS. 1 and 2, a motorcycle 20 includes a front wheel 24, a rear wheel 28, a frame 30, and an engine 32, which provides power to drive the rear wheel 28. As illustrated, the engine 32 is a V-twin configuration, but other configurations are optional. The engine 32 is liquid-cooled, and is provided with a pair of side-mounted radiator assemblies 36. The radiator assemblies 36 each include a housing 40 and a radiator 44. Each radiator 44 is positioned within the respective housing 40 so that the housing 40 substantially surrounds or encloses the radiator 44. The housings 40 include respective openings 48, which are oriented generally in a forwardly-facing direction of the motorcycle 20 so that air can enter the housings 40 and flow over and/or through the radiators 44. A coolant fluid is circulated through the radiators 44 and through cooling passages (not shown) of the engine 32 in order to transfer heat away from the engine 32.

Although the motorcycle 20 is illustrated with a radiator assembly 36 on each side, a majority of the detailed description below is directed to a single one of the radiator assemblies 36. It should be noted that some embodiments of the invention do not require more than one radiator assembly 36 and that the two illustrated radiator assemblies 36 and corresponding mounting arrangements are mirror image replicas of each other. In light of the description of one radiator assembly 36 and its mounting arrangement provided below, further description particularly directed to the opposite radiator assembly 36 is not given.

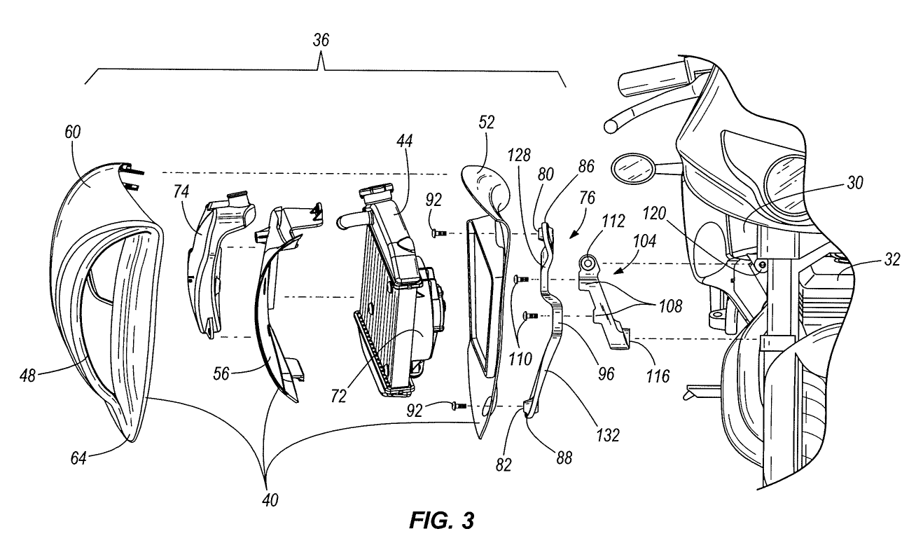

FIG. 3 is an exploded front view illustrating the components of one of the radiator assemblies 36. As shown in FIG. 3, the housing 40 of the radiator assembly 36 includes an inner shroud 52, an inlet duct 56, an outer shroud 60, and a bezel 64. As shown, the bezel 64 is assembled with the outer shroud 60. The bezel 64 defines the opening 48 of the radiator housing 40. The inner shroud 52 is mounted on the motorcycle 20 as described in further detail below. The inlet duct 56 and the outer shroud 60 trap the radiator 44 in position against the inner shroud 52. The housing 40 can be assembled in various ways, including fastening the outer shroud 60 and the bezel 64 to the inner shroud 52. The inlet duct 56 can be coupled to either the outer shroud 60 or the inner shroud 52, or alternatively, the inlet duct 56 can be trapped in position with the radiator 44 between the outer shroud 60 and the inner shroud 52 without additional fastening structure. In some embodiments, the outer shroud 60 includes at least one mounting location for mounting directly to the frame 30 or the engine 32 of the motorcycle 20 in addition to being mounted on the motorcycle 20 via the inner shroud 52.

A fan assembly 72 is mounted directly to an interior side of the radiator 44. The fan assembly 72 is configured to generate a forced flow of air through the radiator 44, for example, when the engine 32 is idling and/or the motorcycle 20 is traveling at a relatively low speed. Also, as illustrated in FIG. 3, the radiator assembly 36 includes a coolant fluid overflow tank 74.

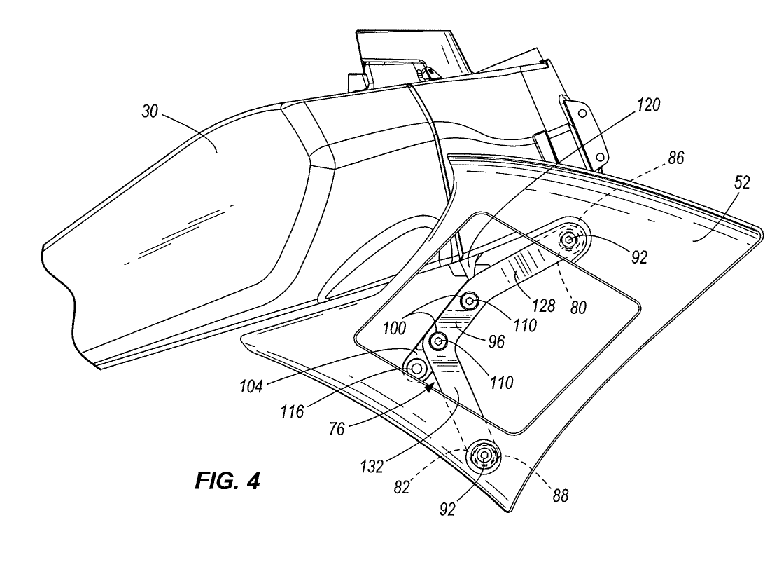

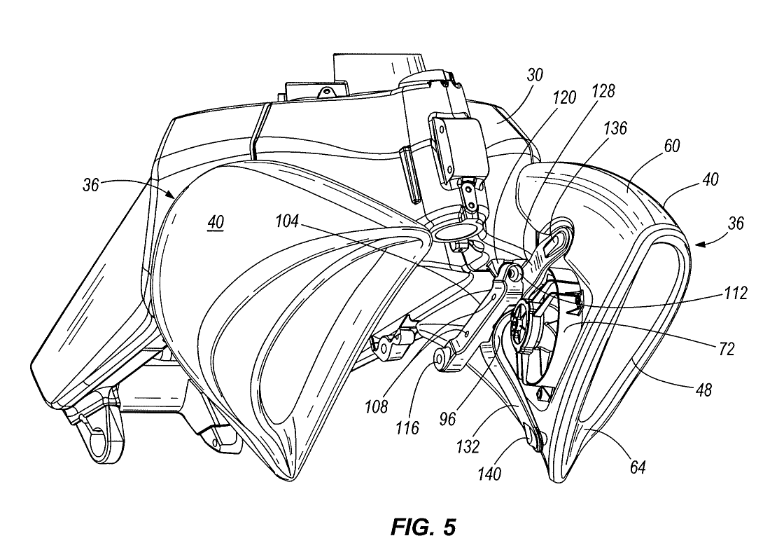

As shown in FIGS. 4 and 5, the inner shroud 52 is mounted to a resilient mounting member 76. The resilient mounting member 76 includes two mounting locations 80, 82, one at each end portion 86, 88 of the resilient mounting member 76. The mounting locations 80, 82 at the end portions 86, 88 of the resilient mounting member 76 can include threaded openings 90 configured to receive threaded fasteners 92. Other fastening configurations for attaching at least a portion of the radiator assembly 36 to the resilient mounting member 76 are optional.

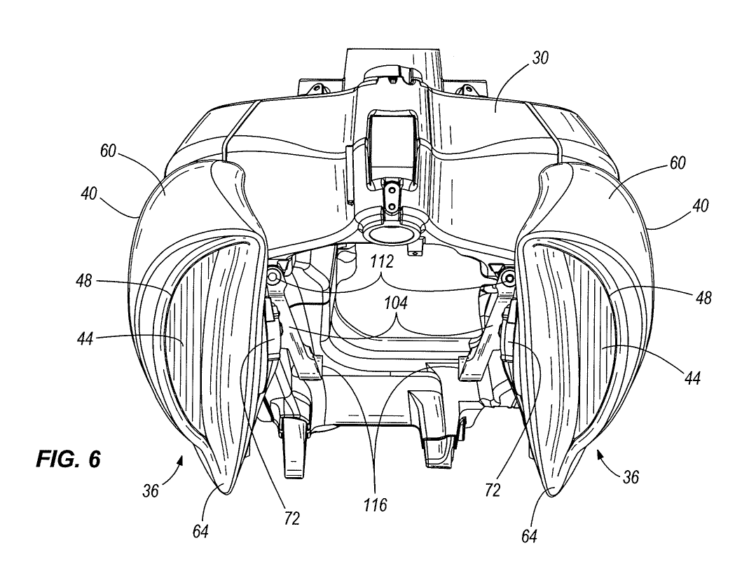

As illustrated in FIGS. 5 and 6, the resilient mounting member 76 includes a central portion 96 having a pair of adjacent mounting locations 100 for mounting the radiator assembly 36 on a rigid structure of the motorcycle 20 (e.g., frame 30, engine 32, etc.). In the illustrated embodiment, the mounting locations 100 on the central portion 96 of the resilient mounting member 76 are configured to attach the resilient mounting member 76 (and thus mount the radiator assembly 36) to a rigid mounting member 104 of the motorcycle 20. The rigid mounting member 104 includes a pair of mounting locations 108 corresponding to the mounting locations 100 on the central portion 96 of the resilient mounting member 76. In some embodiments, the mounting locations 100 on the central portion 96 of the resilient mounting member 76 are through holes, and the corresponding mounting locations 108 on the rigid mounting member 104 are threaded holes configured to receive threaded fasteners 110, but other configurations are optional.

The rigid mounting member 104 further includes mounting locations 112, 116 configured to be coupled to the frame 30 and to the engine 32, respectively. The first mounting location 112 is configured to be coupled to a mount 120 (e.g., a casting with a threaded hole) of the frame 30. The second mounting location 116 is configured to be coupled to a mount (not shown), such as a casting with a threaded hole, of the engine 32.

Thus, the mounting arrangement for the radiator assembly 36 is substantially rigid in one region and substantially resilient in another region. The rigid mounting member 104 is coupled to both the frame 30 and the engine 32, which are also securely mounted to each other at additional mounting locations. Therefore, the rigid mounting member 104 is configured to remain substantially stationary with respect to the frame 30 and the engine 32 and to provide a rigid structure to which the radiator assembly 36 can be mounted. In some embodiments, the rigid mounting member 104 is constructed of aluminum (e.g., forged 6061 aluminum alloy).

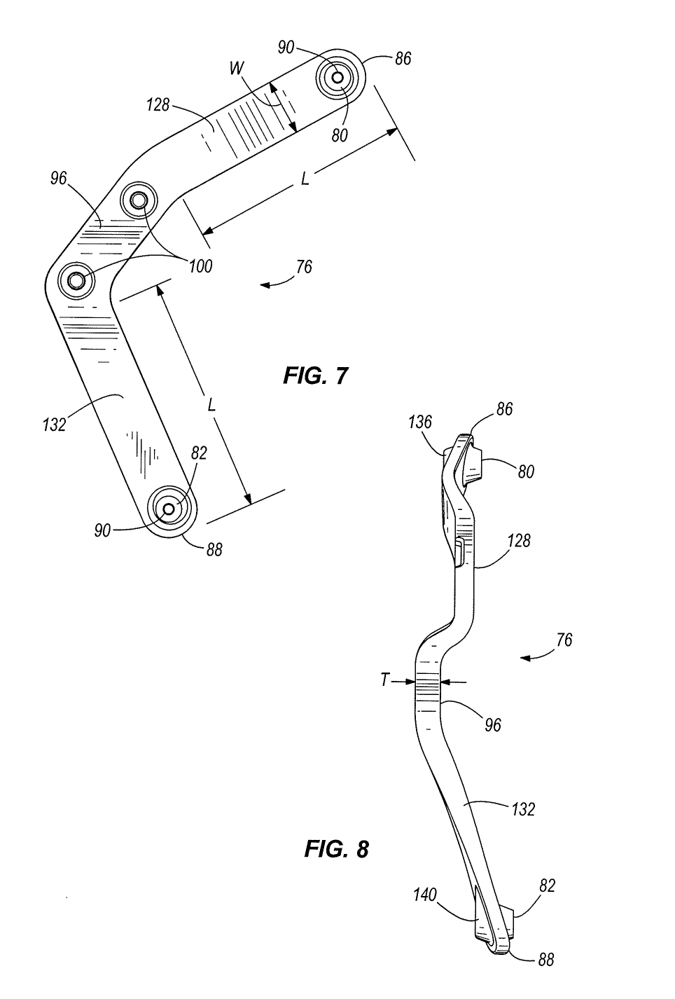

As shown in FIGS. 7 and 8, the resilient mounting member 76 includes a first resilient leg portion 128 extending from the central portion 96 in a first direction and terminating at the first end portion 86. The resilient mounting member 76 also includes a second resilient leg portion 132 extending from the central portion 96 in a second direction and terminating at the second end portion 88. The resilient mounting member 76 as a whole is generally boomerang-shaped or V-shaped. In some embodiments, the resilient mounting member 76 is constructed of aluminum (e.g., forged 6061 aluminum alloy).

Each of the resilient leg portions 128, 132 of the resilient mounting member 76 has a length L between the central portion 96 and the respective end portions 86, 88. Furthermore, the resilient leg portions 128, 132 have respective widths W and thicknesses T. Generally, the resilient leg portions 128, 132 are long and flat, the length L being greater than the width W, and the width W being greater than the thickness T. In addition, the thickness T decreases along the resilient leg portions 128, 132 from the central portion 96 to the respective end portions 86, 88.

The configuration of the resilient mounting member 76, and particularly the configuration of the resilient leg portions 128, 132, allows for substantial deflection at the end portions 86, 88 while the central portion 96 remains substantially fixed with respect to the rigid mounting member 104, the frame 30, and the engine 32. The configuration of the resilient mounting member 76, and particularly the configuration of the resilient leg portions 128, 132, allows for substantial deflection within the elastic deformation range so that the radiator assembly 36 can move a substantial distance relative to the frame 30 and the engine 32 without permanently deforming the resilient mounting member 76.

Even though the resilient mounting member 76 is constructed of the same or similar material as the rigid mounting member 104 in some embodiments, the configuration of the resilient mounting member 76 (including the shape and relative dimensions of the resilient leg portions 128, 132 and the arrangement of the mounting locations 80, 82, 100) enable the resilient mounting member 76 to undergo a significant amount of deflection without plastic deformation or breakage.

As illustrated in FIG. 8 and due to the small thickness T at the end portions 86, 88 of the resilient leg portions 128, 132, the resilient mounting member 76 includes localized bosses 136, 140 that provide ample depth for the threaded opening 90 at each of the mounting locations 80, 82. The expanse of the localized bosses 136, 140 is limited to the immediate area of the mounting locations 80, 82 so as to avoid interfering with the resilient performance of the resilient leg portions 128, 132 as described above.

The resilient mounting arrangement of the radiator assembly 36 provides an energy absorption mechanism between the radiator assembly 36 and the remainder of the motorcycle 20. Specifically, the resilient mounting arrangement of the radiator assembly 36 provides an energy absorption mechanism between the radiator housing 40 and both the frame 30 and the engine 32. In a tip over event of the motorcycle 20, for example, the resilient mounting arrangement (and particularly the deflection afforded by the resilient mounting member 76) protects the radiator 44, the frame 30, and the engine 32 from damage due to impact. The housing 40 may contact the ground or another object and receive an impact force. Some of the impact force is then absorbed by the mounting arrangement including the resilient mounting member 76. The energy-absorbing elastic deformation of the resilient mounting member 76 limits the impact force transmitted to the frame 30 and the engine 32. The energy-absorbing elastic deformation of the resilient mounting member 76 also limits the compressive force on the housing 40 between the struck object and the mounting arrangement, which can help prevent crushing of the housing 40 and damage to the radiator 44 therein. Therefore, the radiator 44, the frame 30, and the engine 32, which are relatively expensive and/or difficult components to repair/replace, may be preserved.

Thus, the invention provides, among other things, a resilient mounting arrangement including a resilient mounting member 76 for mounting a radiator assembly 36 on a motorcycle 20. Various features and advantages of the invention are set forth in the following claims.

What is claimed is:

1. A mounting arrangement for mounting a radiator assembly on a motorcycle, the mounting arrangement comprising:
a radiator housing; and
a resilient mounting member coupled to the radiator housing and configured to secure the radiator assembly on the motorcycle, the resilient mounting member being configured to absorb impact loads to the radiator assembly by elastic deformation.

2. The mounting arrangement of claim 1, wherein the resilient mounting member is generally elongated, having a central portion and two opposing end portions.

3. The mounting arrangement of claim 2, wherein the central portion is coupled to a rigid structure of the motorcycle, the two opposing end portions being generally cantilevered from the rigid structure.

4. The mounting arrangement of claim 3, wherein the radiator housing is coupled to the resilient mounting member at each of the two opposing end portions.

5. The mounting arrangement of claim 4, wherein the resilient mounting member includes a threaded hole at each of the two opposing end portions.

6. The mounting arrangement of claim 3, wherein the central portion is coupled to a first mount on a frame of the motorcycle and a second mount on the engine of the motorcycle.

7. The mounting arrangement of claim 6, wherein the central portion is coupled to the first mount and the second mount by a rigid mounting member.

8. The mounting arrangement of claim 1, wherein the radiator housing is configured to substantially surround the radiator, the radiator housing defining an opening oriented towards a forward direction of the motorcycle.

9. A motorcycle comprising:
a frame;
an engine;
a radiator in fluid communication with the engine; and
a mounting arrangement for mounting the radiator on the motorcycle, the mounting arrangement including a resilient mounting member positioned between the radiator and at least one of the frame and the engine.

10. The motorcycle of claim 9, wherein the radiator is positioned on a lateral side of the motorcycle.

11. The motorcycle of claim 9, further comprising a radiator housing.

12. The motorcycle of claim 11, wherein the resilient mounting member is coupled to the radiator housing and at least one of the frame and the engine.

13. The motorcycle of claim 12, wherein the resilient mounting member is coupled to at least one of the frame and the engine via a rigid mounting member.

14. The motorcycle of claim 13, wherein the rigid mounting member is coupled to the frame and to the engine.

15. A mounting member for mounting a radiator assembly on a motorcycle, the mounting member comprising:
a central portion including a mounting location configured to be attached to a rigid structure of the motorcycle;
a first resilient leg extending outwardly from the central portion and including a mounting location configured to be attached to the radiator assembly; and
a second resilient leg extending outwardly from the central portion and including a mounting location configured to be attached to the radiator assembly.

16. The mounting member of claim 15, wherein the rigid structure of the motorcycle is a rigid mounting member.

17. The mounting member of claim 15, wherein the mounting locations of the respective first and second resilient legs are attached to a housing of the radiator assembly.

18. The mounting member of claim 17, wherein the mounting locations of the respective first and second resilient legs are attached to an inner shroud of the housing.

19. The mounting member of claim 15, wherein each one of the first resilient leg and the second resilient leg has a thickness decreasing in size with increasing distance from the central portion.

20. The mounting member of claim 15, wherein the mounting member is constructed of an aluminum alloy.
